(19) United States
(12) Patent Application Publication
(10) Pub. No.: US 2012/0305721 A1
(43) Pub. Date: Dec. 6, 2012

(54) Multifunction Peg

(76) Inventor: Kuo-Chi LIN, New Taipei (TW)

(21) Appl. No.: 13/153,480

(22) Filed: Jun. 6, 2011

(51) Int. Cl. F16M 13/02; F16B 2/10

(52) U.S. Cl. 248/224.8

(57) ABSTRACT

A multifunction peg comprises a main body and two second pressing arms. Each second pressing arm includes a through hole and two hooks. A through hole is formed at an upper part of the second pressing arm, and includes a large round hole, two middle round holes and two small holes, for fitting and receiving a salient or a nail. The multifunction peg can hold an article and versatilely engage with a salient or a nail prefixed to a wall or a wooden board, thereby getting fixed in position.

### BACKGROUND OF THE INVENTION

1. Field of the Invention

The present invention relates to pegs, and particularly to a multifunction peg that can hold an article and versatilely engage with a salient or a nail prefixed to a wall or a board, thereby getting fixed in position.

2. Related Art

While many pegs have been developed and sold, most of them are limited to the usage of carrying an article, such as clothes. When a user intends to use such a conventional peg for pegging clothes, he/she has to place the peg on a table or on the ground first. Sometimes there may even be not such a place to place the peg stably. At this time, if something else interrupt his/her work, when later coming bake to peg clothes, he/she may have problem to retrieve the peg he/she incidentally put previously and need to find out the peg. For the above reasons, the conventional peg is disadvantageous and inconvenient in use.

In view of the problem of the prior art, the inventor of the present invention, with his years of experience, has paid effort to conduct thorough research and active development in order to invent a multifunction peg that is easy to move and can be fixed in position at will.

### SUMMARY OF THE INVENTION

The primary objective of the present invention is to provide a multifunction peg that can carry articles and be conveniently, rapidly fixed to a salient or a nail prefixed to a wall or a wooden board.

To this end, the multifunction peg of the present invention comprises a main body and two second pressing arms. The main body has a jaw portion and two first pressing arms. The first pressing arm has a to-be-pressed portion at an upper part thereof and a waterdrop-shaped hole. The second pressing arms are extended from the to-be-pressed portions of the first pressing arms of the main body downward, respectively. The second pressing arm includes a through hole and two hooks and therefore can be hung on a clothesline, a clotheshorse, a stick, a wire, a rope and the like. The through hole is formed at an upper part of the second pressing arm, and includes a large round hole, two middle round holes, and two small holes, for fitting and receiving a salient or a nail. The two hooks are located at a middle part of an outer side of the second pressing arm for insertion. The multifunction peg of the present invention can carry articles and be conveniently, rapidly fixed in position at will.

### BRIEF DESCRIPTION OF THE DRAWINGS

FIG. 1 is a perspective view of the multifunction peg.

FIG. 2 is a front view of the multifunction peg.

FIG. 3 is a front view of a second pressing arm of the multifunction peg.

### DETAILED DESCRIPTION OF THE PREFERRED EMBODIMENTS

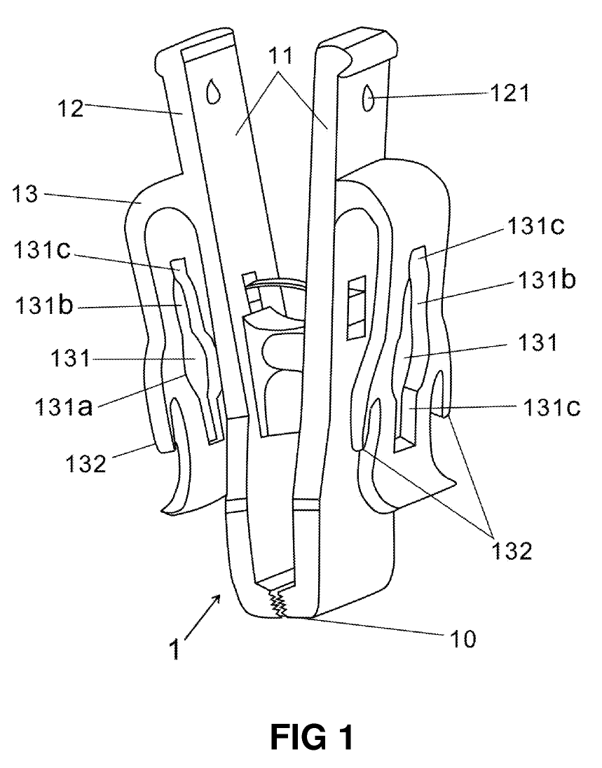

Referring to FIGS. 1, 2 and 3, a perspective view and a front view of a multifunction peg and a front view of a second pressing arm of the multifunction peg according to the present invention are provided. The disclosed multifunction peg is formed as a unity having a main body 1, and two second pressing arms 13. The main body 1 includes a jaw portion 10, two first pressing arms 11 and two to-be-pressed portions 12. Each of the jaw portion 10 of the main body 1 is at an end of a long arm, namely the first pressing arm 11, while the to-be-pressed portions 12 is at an opposite end of the first pressing arm 11. The to-be-pressed portion 12 is formed with a waterdrop-shaped hole 121, for allowing a rope or a wire to pass therethrough and string plural said multifunction pegs up. The second pressing arms 13 are located below the to-be-pressed portions 12. The to-be-pressed portions 12 of the first pressing arms 11 are configured to be pressed for opening the jaw portion 10 of the disclosed multifunction peg. By easily drawing the to-be-pressed portions 12 together with a minor force, the jaw portion 10 can be opened to release an article it holds. The second pressing arms 13 are designed for hanging the multifunction peg carrying an article on a clothesline, a clotheshorse, a stick, a wire, a rope and the like at a user's will so that there is no need for finding out the peg that might otherwise be placed incidentally and lost, thus being convenient and facilitating efficient pegging work.

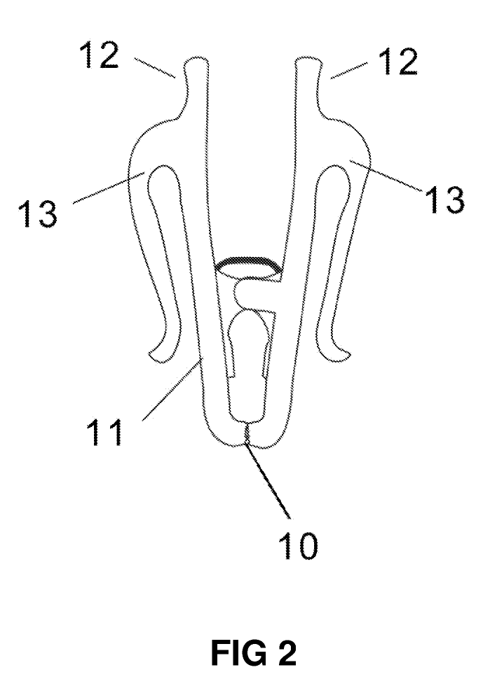

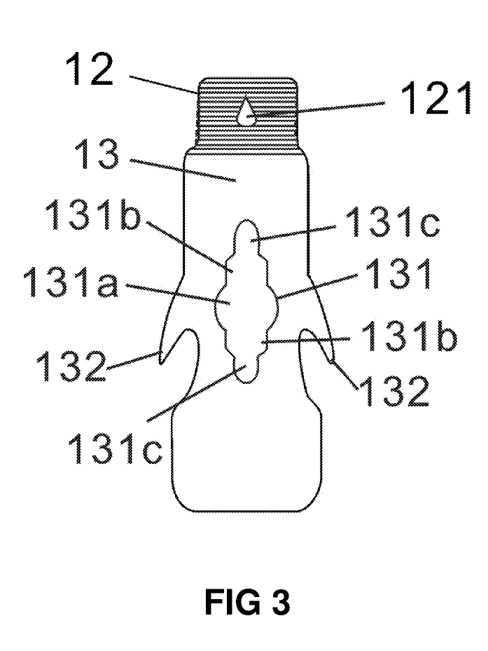

Referring again to FIGS. 2 and 3, the second pressing arm 13 is a hook-like component for hanging the main body 1 carrying an article on an external support. The second pressing arm 13 is formed with a through hole 131 and two hooks 132. The through hole 131 is provided at an upper portion of the second pressing arm 13 and consists of a large round hole 131a, two middle round holes 131b and two small holes 131c, so as to fit and engage with salients and nails of different sizes. A salient or nail is large can be received or fitted in the large round hole 131a of the through hole 131. A salient or nail is relatively small can be received or fitted in the middle round hole 131b of the through hole 131. A salient or nail is even smaller can be received or fitted in the small hole 131c of the through hole 131. Thereby, the main body 1 carrying an article can be easily attached to a salient or nail prefixed to a wall or wooden board. In addition, the hooks 132 located at a middle part of an outer side of the second pressing arm 13 are configured to engage with an external grid so as to attach the main body 1 carrying an article to the external grid. Since the second pressing arms 13 of the multifunction peg can be fixed almost anywhere, the main body 1 carrying an article can be hanged on a rope or a stick conveniently. Furthermore, the through hole 131 can fit and receive a salient or nail prefixed to a wall or wooden board. Moreover, the hooks 132 can be inserted and engage with an external grid. Hence, the multifunction peg allows the main body 1 carrying an article to be fixed in position in many ways.

1. A multifunction peg, comprising a main body and two second pressing arms, wherein:
the multifunction peg being formed as a unity, and the main body including a jaw portion and two first pressing arms;
the jaw portion being located at a front end of the main body for holding or releasing an external article;
the first pressing arms defining two laterals of the main body, each said first pressing arm having a to-be-pressed portion at an upper part thereof, the to-be-pressed portion being formed with a waterdrop-shaped hole for allowing plural said multifunction pegs to be strung up;
each said second pressing arm being extended downward from the to-be-pressed portion of the first pressing arm, for engaging with an external hanging support;
the second pressing arm including a through hole and two hooks;
the through hole being formed at an upper part of the second pressing arm, the through hole including a large round hole, two middle round holes and two small holes, for fitting and receiving external salients or nails of various sizes so as to fix the peg to the salients or nails;
the two hooks being located at a middle part of an outer side of the second pressing arm, for being inserted to an external grid and fixing the multifunction peg to the grid.

2. The multifunction peg according to claim 1, wherein the to-be-pressed portions at the upper parts of the first pressing arms are such configured that when the to-be-pressed portions are drawn together with a minor force, the jaw portion is opened, so as to allow effort-saving operation.

3. The multifunction peg according to claim 1, wherein the waterdrop-shaped holes are formed on the to-be-pressed portions respectively, for being passed through by an external wire or cord that strings up plural said multifunction pegs.
